(19) United States
(12) Patent Application Publication
(10) Pub. No.: US 2013/0149070 A1
(43) Pub. Date: Jun. 13, 2013

(54) Fastening Element

(71) Applicant: Uwe Frank, Pfedelbach-Windischenbach (DE)

(72) Inventor: Uwe Frank, Pfedelbach-Windischenbach (DE)

(21) Appl. No.: 13/817,023

(22) PCT Filed: Aug. 23, 2011
(86) PCT No.: PCT/EP2011/064470

§ 371 Date: Feb. 14, 2013

(30) Foreign Application Priority Data
Aug. 24, 2010 (DE) 10 2010 039 659.1

(51) Int. Cl. F16B 35/00; F16B 19/08; F16B 15/00

(52) U.S. Cl. CPC F16B 35/005; F16B 15/00; F16B 19/08
USPC 411/394; 411/487

(57) ABSTRACT

A fastening element, which may be in the form of a blind rivet or a screw, is intended to be driven into an unperforated workpiece. In its front region that is intended to be driven into the workpiece, it includes a punching tip which is formed in a cylindrical manner and has a front end face which extends obliquely to the longitudinal axis. The punching tip may be smaller in diameter than the body of the fastening element or else have the same diameter. The section between the end face and the outer side of the punching tip forms a circumferential edge. On account of the oblique profile of the end face, this circumferential edge is arranged such that when the fastening element is driven in, the circumferential edge first of all strikes the metal sheet at one or at two points and the opening in the metal sheet is enlarged by shearing of the metal sheet at a point that moves around the circumference.

The invention relates to a fastening element which is driven into a non-perforated underlying surface in an abrupt movement.

There is already known a gun rivet, which is driven into a non-perforated workpiece with the aid of a firing device. At its end facing the workpiece, this rivet mandrel has a tip which can also be formed in a pyramid shape (EP 1085952). Such a tip, which is conventional in gun rivets, makes penetration into the non-perforated workpiece easier.

However, it has been found that in certain applications, the deformation, caused by such a tip, of the workpiece in the region of the fastening point leads to unsuitable results.

The invention is based on the object of creating a fastening element suitable for driving into a non-perforated workpiece, said fastening element having a simple structure and leading to less deformation of the workpiece in the region of the fastening brought about by the fastening element.

In order to achieve this object, the invention proposes a fastening element having the features mentioned in claim 1. Developments of the invention are the subject matter of dependent claims.

Thus, in the region of its front end facing the workpiece, the fastening element includes, as tip, a punching section having an end face which is bounded by a circumferential edge. This end face, and thus also the circumferential edge bounding it, is now not located in a plane which extends perpendicularly to the longitudinal axis. As a result, the circumferential edge of the end face hits the workpiece first of all at a point, such that the opening of the workpiece begins there at a point. Upon further penetration of this punching section, all points of the circumferential edge gradually come into contact with the workpiece, such that the opening is produced gradually, in a similar manner to shearing. As a result, the workpiece is deformed less severely in the region of the opening and also there is no excessive braking of the fastening element. In addition, on account of the shearing of a part of the workpiece, a hole with a clean periphery is produced. Such a clean periphery does not tend to tear, as can occur in the case of a hole produced by a tip.

As soon as the hole has been virtually completely formed, the pressure section of the punching tip strikes the surface of the metal sheet and pushes the punched-out piece still hanging on the metal sheet forwards in the driving-in direction, so that said punched-out piece is raised and deflected. Since the pressure section of the punching tip is also bounded by the circumferential edge, the latter acts on the punched-out piece and turns the punched-out piece in the direction of the rear side of the lower metal sheet.

The mentioned pressure section of the punching tip can be formed in that this region of the end face extends less obliquely than the punching section that strikes the workpiece first. For example, the pressure section can extend at an angle of about 10° with respect to a perpendicular transverse plane of the fastening element.

It may likewise be provided for the pressure section to be located in a plane that extends perpendicularly to the longitudinal axis of the fastening element.

According to the invention, it may be provided for the pressure section to form, in the region of that end of the end face that is located closest to the head of the fastening element, a short protrusion that is directed away from the head of the fastening element. When this end of the end face reaches the workpiece with the associated circumferential edge, that part of the workpiece that is sheared off to form the hole is detached almost completely from the workpiece. This last short protrusion likewise deflects the punched-out piece in the direction of the rear side of the workpiece.

The beginning of the pressure section, or in other words the boundary between the punching section and the pressure section of the punching tip, can be located for example at a point which is smaller than or equal to about 25% of the diameter of the punching face.

In order that such a clean hole can be punched even under aggravated conditions, according to the invention it may be provided in a development for the front punching tip of the fastening element to have a cylindrical, in particular circular-cylindrical outer contour.

In a further development of the invention, it may be provided for the circumferential edge to be formed by a section line between the end face of the fastening element and a cylindrical outer contour of the fastening element, preferably by the cylindrical outer contour of the punching tip.

In a further development of the invention, it may be provided for the punching tip to have a smaller cross section than the actual body of the fastening element. It has been found that the formation of a hole with a smaller cross section than corresponds to the cross section of the fastening element both leads to good results in the configuration of the fastening and also means that the effort for driving in such a fastening element does not become too large.

In order to achieve this, it may be provided according to the invention for a transitional section which establishes the transition between the larger cross section and the smaller cross section to be arranged between the front punching tip and the fastening element body.

This transitional section can have various shapes. For example, the transitional section can extend in a conical manner, that is to say with a rectilinearly extending side line.

It is likewise possible and is proposed by the invention for the transitional section to extend in a ballistic manner, i.e. the side line to be convexly curved.

A further possibility proposed by the invention is for the transitional section to have a concavely curved side line.

In particular, it may also be provided for the side line of the transitional section to be composed of sections having different configurations, i.e. ballistic, conical and concave sections.

The punching and/or pressure section can extend in each case in a planar manner and in each case obliquely to the longitudinal axis, in particular at different angles.

However, the end face does not have to be planar; it can also have other shapes. Thus, it is for example possible and is proposed by the invention for the front end of the punching tip to have an additional cutting edge which extends over the front end and divides the end face into two parts. The cutting edge extends from a part of the circumferential edge to the opposite section of the circumferential edge, and thus transitions at its two ends into the circumferential edge. The end face can also be formed in each case in a planar manner on both sides of the cutting edge. However, this is only one possibility.

According to the invention, it may be provided for this cutting edge to extend perpendicularly to the longitudinal axis of the fastening element. Then, the production of the opening begins in the middle of the punched-out piece.

However, it is likewise possible and is proposed by the invention for this cutting edge to extend perpendicularly to the longitudinal axis of the fastening element.

It is expedient if, according to a further feature of the invention, the cutting edge extends through the center axis of the fastening element.

According to the invention, it may be provided for this cutting edge to form a rectilinear edge.

However, it is likewise possible and is proposed by the invention for this cutting edge to be formed in a curved manner in a side view of the fastening element, the cutting edge in this case likewise being intended to extend in a rectilinear manner in an end view of the fastening element.

It may also be expedient in individual cases, in particular in the case of relatively large diameters, for the fastening element to be able to have a plurality of such cutting edges.

As seen in end view, the circumferential edge extends along a closed line, preferably a circular line.

The fastening element can be in the form for example of a gun rivet. However, it may also be in the form of a screw which can be fired into the workpiece until an opening is formed in the workpiece in the manner of a rim hole, it being possible to screw the thread of the screw into said opening in order to shape the mating thread there.

It is also conceivable for the fastening element to have encircling grooves which do not form a thread but can contribute toward better fixing.

Further features, details and advantages of the invention will become apparent from the claims and the abstract, the wording of both of which is incorporated into the content of the description by reference, from the following description of preferred embodiments of the invention and by way of the drawing, in which:

FIG. 1 shows the side view of a fastening element in the form of a hollow rivet;

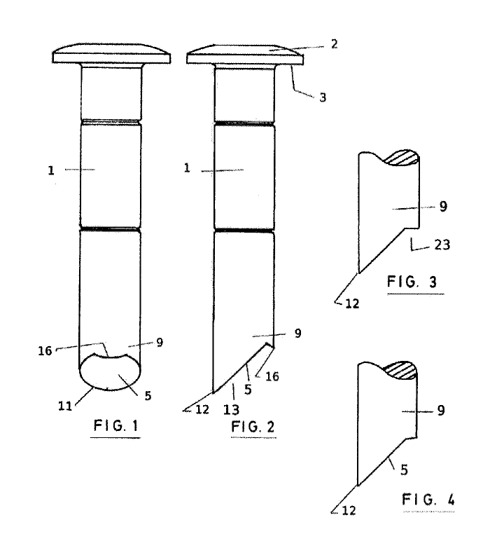

FIG. 2 shows the side view of the fastening element from a different direction;

FIG. 3 shows the front end of a fastening element modified with respect to the embodiment according to FIG. 2;

FIG. 4 shows an illustration corresponding to FIG. 3 of a further modified embodiment;

FIG. 5 shows the side view of a fastening element having a transitional region;

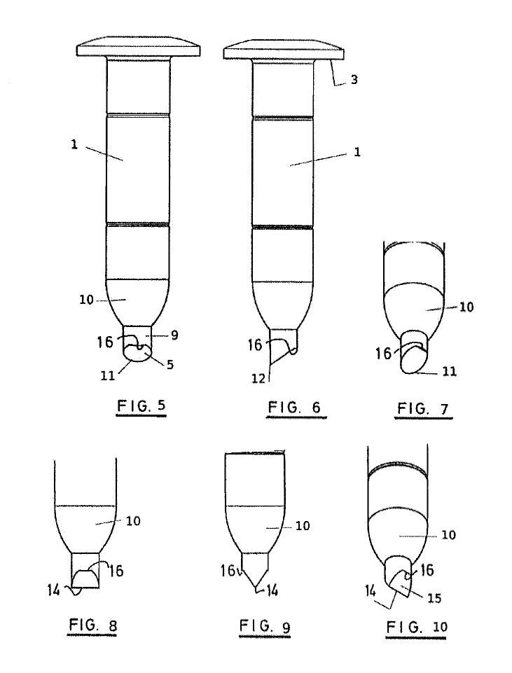

FIG. 6 shows the side view of the fastening element in FIG. 5 from a different direction;

FIG. 7 shows the perspective view of the embodiment according to FIGS. 5 and 6;

FIG. 8 shows the side view of a third embodiment;

FIG. 9 shows the side view of the embodiment in FIG. 8 from a different direction;

FIG. 10 shows the perspective view of the embodiment according to FIGS. 8 and 9.

FIG. 1 shows, as an example of a fastening element proposed by the invention, a hollow rivet having a body 1, at one end of which there is formed a head 2. The head 2 protrudes radially beyond the cylindrical section of the body 1. Its underside forms an abutment shoulder 3 which comes into abutment with the top side of the workpiece in the fastened state. In the region of its front end 4 assigned to the workpiece, the fastening element has an end face 5, which is only indicated here.

A second example of the type of fastening element in which the invention can be used is a breakstem rivet.

A third example of a fastening element on which the invention can be realized is a punch screw.

Formed in the region of the front end, that is to say that end of the fastening element that is remote from the screw head 2, is a punching tip 9, which is bounded by an obliquely extending end face 5.

The end face 5 is planar and extends at an angle of approximately 45° to the longitudinal axis of the fastening element in the form of a hollow rivet. In this embodiment, the punching tip 9 has the same cross-sectional shape and the same diameter as the cylindrical section of the body 1 of the hollow rivet.

That point of the punching tip 9 that is at the greatest distance from the abutment shoulder 3 of the head 2 of the fastening element forms a tip 12. As can be seen from FIG. 1, the circumferential edge 11 is naturally curved at this point, but nevertheless a tip 12 is formed. That region of the punching tip 9 that adjoins this tip 12 forms a punching section 13. When the punching tip 9 penetrates into the workpiece, a punching operation takes place by way of the circumferential edge 11.

At that point of the end face 5 that is furthest away from the leading tip 12, a short, forwardly projecting protrusion 16 is formed as pressure section. This protrusion 16 is directed away from the head 2 of the rivet in the direction of the workpiece. During the penetration of a workpiece, the punched-out piece is first of all detached at the tip 12 of the rivet. Shortly before the punching spot is almost completely sheared off, the protrusion 16 strikes it. The latter ensures that, shortly before complete puncturing, the punched-out piece is not torn off but is raised, bent to the side and turned in the direction of the rear side of the workpiece.

FIG. 3 shows, in an illustration corresponding to FIG. 2, only the front region of the body 1 of a fastening element according to another embodiment. Whereas in the embodiment of FIGS. 1 and 2 the pressure section of the punching tip 9 is formed by a protrusion 16 pointing in the direction away from the head 2 of the fastening element, the embodiment in FIG. 3 shows a pressure section 23 which has an end face extending perpendicularly to the longitudinal axis. In this embodiment, toward the end of the driving-in operation, this end face simultaneously strikes the punched-out piece. This too results in the punched-out piece not being detached, but being folded over.

FIG. 4 shows a further embodiment, in which the pressure section 23 has an end face which is inclined in the same direction as the end face 5 of the punching section 13, but is oriented much closer to the transverse plane extending perpendicularly to the longitudinal axis. The angle which this end face 23 encloses with this transverse plane is for example about 10°.

Whereas in the embodiment according to FIG. 1 to FIG. 4 the punching tip 9 is a cylindrical extension of the body 1 of the fastening element, the following figures show embodiments in which a transitional section 10 is arranged between the body 1 of the fastening element and the punching tip 9. As a result of this transitional section 10, the punching tip 9 has a much smaller diameter or cross-sectional area than the diameter of the body 1 of the fastening element. Thus, it is possible for the hole produced by the punching tip 9 to be smaller than corresponds to the diameter of the fastening element body. As a result, the transitional section 10 widens the punched hole, thereby leading to the formation of a rim hole in the peripheral region of the hole. This rim hole formation can lead to an improved attitude of the fastening element in the peripheral region of the sheet metal element.

In the embodiment in FIG. 5 to FIG. 7, the front section of the punching tip 9 has the same shape as in the previous embodiment according to FIG. 1 and FIG. 2. Thus, right at the front on the punching section there is formed a planar, obliquely extending face 5 which has a circumferential punching edge 11. At that point 12 that is closest to the underside 3 of the head 2, the abovementioned, forwardly directed short protrusion 16 is formed. Here, too, the plane of the end face 5 extends approximately at an angle of 45° with respect to the longitudinal axis.

FIG. 7 shows only the front region of the fastening element in a perspective illustration.

In the figures dealt with so far, the end face 5 is in the form of a planar face. However, it could also be in the form of a curved face.

The further embodiment, illustrated in FIGS. 8 to 10, of a fastening element differs from the embodiment in FIG. 5 to FIG. 7 in that two planar end faces 15 are formed at the front end of the punching tip. The two end faces extend approximately at an angle of 45° with respect to the longitudinal axis, such that they both enclose an angle of about 90° with one another. The cutting edge 14 formed as a result at the front end of the punching tip extends perpendicularly to the longitudinal axis in the example illustrated. The two end faces 15 on both sides of the cutting edge 14 are arranged symmetrically to one another. In this embodiment, the punched-out piece is first of all punctured in the middle and then gradually sheared off on both sides of the parting line created by the cutting edge 14. In the most favorable case, this produces two punched-out pieces, which are then deflected by the protrusions 16 shortly before complete puncturing.

The cutting edge 14 illustrated as perpendicular to the longitudinal axis of the rivet in FIG. 8 could also extend obliquely with respect to the longitudinal axis of the fastening element in order as a result to start puncturing at the periphery of the hole to be formed. It could also be curved in a more or less strongly concave or convex manner.

It has already been mentioned that the transitional section 10 between the body 1 of the fastening element and the punching tip 9, 19 serves to deform the periphery of the hole produced by the punching tip 9, 19 in order as a result to enlarge the hole. The shape of the transitional section 10 is formed with a convex side contour in the exemplary embodiments illustrated. Instead of this, the transitional section can also be formed in a conical manner, such that its side contour extends rectilinearly.

A concave side contour is also expedient.

Depending on the circumstances in each individual case, a combination of these shapes can also be used.

The pressure section of the punching tip 9 of the embodiments according to FIGS. 5 to 10 corresponds to that of the embodiment according to FIGS. 1 and 2. In these embodiments, too, the pressure section could have the shape and arrangement as in the embodiment according to FIGS. 3 and 4. However, this is not illustrated in detail.

1. A fastening element for driving in, having
a fastening element body (1) which
has a head (2) having an abutment shoulder (3) on its underside, and
a punching tip (9) forming the front end of the fastening element, said punching tip (9)
having an end face (5) bounded by a circumferential edge (11), said end face (5) having
a punching section which strikes a workpiece first, and
a pressure section which strikes the workpiece last.

2. The fastening element as claimed in claim 1, wherein the punching tip (9) has a cylindrical, in particular circular-cylindrical outer contour.

3. The fastening element as claimed in claim 1, wherein the circumferential edge (11) is formed by a section line between the end face (5) and a cylindrical outer contour of the fastening element, preferably the cylindrical outer contour of the punching tip (9).

4. The fastening element as claimed in claim 1, having
a transitional section (10) arranged between the punching tip (9) and the fastening element body (1), wherein
the cross section of the punching tip (9) is smaller than the cross section of the fastening element body (1).

5. The fastening element as claimed in claim 4, wherein the transitional section (10) extends at least partially in a conical or concave manner.

6. The fastening element as claimed in claim 4, wherein the transitional section (10) is formed at least partially in a ballistic manner.

7. The fastening element as claimed in claim 1, wherein at least one of the punching section and the pressure section of the end face (5) are each formed in a planar manner and each extend obliquely to the longitudinal axis of the fastening element, in particular at different angles.

8. The fastening element as claimed in claim 1, having at least one cutting edge (14) which divides the end face (15) and transitions at its two ends into the circumferential edge (11).

9. The fastening element as claimed in claim 8, wherein the cutting edge (14) extends perpendicularly or obliquely to the longitudinal axis of the fastening element.

10. The fastening element as claimed in claim 8, wherein the cutting edge (14) is formed in a rectilinear or curved manner.

11. The fastening element as claimed in claim 8, wherein the cutting edge (14) extends through the center axis of the fastening element.

12. The fastening element as claimed in claim 1, wherein the circumferential edge (11) extends, as seen in end view, along a closed circular line.

13. The fastening element as claimed in claim 1, wherein the fastening element body is in the form of a screw.

14. The fastening element as claimed in claim 1, wherein the fastening element body is in the form of a rivet body.
